(19) United States
(12) Patent Application Publication
(10) Pub. No.: US 2017/0080263 A1
(43) Pub. Date: Mar. 23, 2017

(54) MASK

(71) Applicants: CHIH-TSUNG CHIU, Nantou County (TW); CHING-MAO PENG, Taichung City (TW)

(72) Inventors: CHIH-TSUNG CHIU, Nantou County (TW); CHING-MAO PENG, Taichung City (TW)

(21) Appl. No.: 14/858,476

(22) Filed: Sep. 18, 2015

(51) Int. Cl. A62B 23/02; A62B 18/00; A62B 18/02; A62B 7/10

(52) U.S. Cl. CPC A62B 23/025; A62B 7/10; A62B 18/006; A62B 18/02

(57) ABSTRACT

The present invention is directed to a mask, which comprises a mask housing, a ring-shaped bladder and an engaging ring. The mask housing 11 has a hole defined at the front side thereof and an opening defined in a rear side thereof. The engaging ring is resilient and detachably attached onto the rear side of the mask housing to allow the ring-shaped bladder firmly engaged within the opening of the mask housing.

### BACKGROUND OF INVENTION

1. Field of Invention

The invention relates to a respiratory mask, filter mask or gas mask, and more especially to a mask which includes configurations of exhaust devices, filter devices and/or ring-shaped bladder that contacts user's face.

2. Related Prior Art

There is a wide variety of prior art with regard to respiratory masks and gas masks. The respiratory masks, such as oxygen mask or medical respiratory mask, are applied for assisting a patient breathe, and the gas masks are used to protect a user from inhaling airborne pollutants and toxic gases. For example, there is a need for a painter to a wear gas mask to filter harmful substances. Furthermore, it is believed that comfortable masks are much more likely to be worn, and thus obtaining a suitable degree of comfort is a primary concern in either respiratory masks or gas masks development. Examples of a conventional respiratory mask 4 are shown in FIG. 15, which has a mask body 41 with a ring gasbag 42 disposed in the rear side of the mask body 41. The ring gasbag 42 directly contacts with user's face that impart softness and comfort to the users. However, the conventional respiratory mask 4 is a one-piece construction that the ring gasbag 42 is adhered to the mask body 41 or molded with the mask body 41. It is thus known that when the ring gasbag 42 is leaking, deformed, damaged or has another problems, like absorbing too much bacteria, viruses or pollutants that cause the reduction of absorption, which renders the mask 4 useless, the whole respiratory mask 4 must be discarded by virtue of undetachable configuration of the mask 4, thereby causing a lot of waste.

Besides, for those masks with filter functions, such as gas masks or filter masks, the masks has a one-way diaphragm valve attached at an air inlet hole thereof that allows the user to exhale therethrough and prevents exterior unfiltered air from going into the masks. The mask has an inhalation filter to draw air in from outside and purify it. It is noted that the user needs to exhale air with a certain force in order to push away the one-way valve. However, if the user's respiratory system shows any weakness, leading to the user's breathing being insufficient, the one-way valve cannot be pushed away completely. This incurs that there is too much of the remaining exhaled air in the mask, which influences the air quality in the mask and hence has difficulties to ensure the user to breathe fresh air.

In addition, the inhalation filter itself has a certain resistance to inhale air that would certainly affect the user to well breathe.

Accordingly, there is a need to solve the foregoing mentioned problems.

### SUMMARY OF INVENTION

The present invention is directed to a mask that can solve the problems existing in the conventional mask, that is the whole mask has to be discarded once the airbag is damaged. Specifically, the present invention is provided with a mask, which comprises a mask housing, a ring-shaped bladder and an engaging ring. The ring-shaped bladder is firmly engaged within an opening of the mask housing by the engaging ring with resilience so as to directly contact the user's face.

Preferably, the mask housing includes an annular groove defined in an inner wall of the opening, and outer edge of the engaging ring is fastened in the annular groove. The engaging ring has a ring-shaped engaging trench defined in inner circular surface thereof, and the ring-shaped bladder is fastened in the ring-shaped engaging trench.

Preferably, the mask housing includes an internal annular groove and an external annular groove each defined in an inner wall of the opening, and the internal annular groove is adjacent to the external annular groove. The ring-shaped bladder is fastened in the internal annular groove, and the engaging ring is fastened in the external annular groove and stop against an edge of the ring-shaped bladder to prevent the ring-shaped bladder from falling off.

The present invention is further directed to a mask which reduces a burden while exhaling and ensures the air in the mask housing fresh. The mask comprises an exhaust assembly, an exhalation valve and an exhaust module. The exhaust assembly is connected to the mask housing. The exhalation valve is attached to a position where is inside of the mask housing or inside of the exhaust assembly, which is configured to prevent exterior air from going into the inside of the mask housing. The exhaust module is disposed in the exhaust assembly, which includes an entrance, an exit and a micropump connected to both of the entrance and the exit. The micropump is provided to suck the air from the mask housing through the entrance and to discharge to the outside of the mask housing through the exit. Preferably, the mask further comprises the aforementioned elements like the ring-shaped bladder and the engaging ring, which features a replaceable ring-shape bladder. More preferably, the exhaust assembly further comprises a bypass channel communicating the entrance and the exit; wherein the bypass channel is configured to be switched on and off selectively. If the user chooses not to turn on the exhaust module, the bypass channel is then opened. This allows the exhaled air to be expelled from the mask housing through a path of the entrance, the bypass channel and the exit.

The present invention is further directed to an easy detachable mask, which comprises a mask housing, an associated seat, at least an inhalation filter and an inhalation valve. The associated seat is fitted into an air inlet hole of the mask housing, which is resilient and has an engaging slot defined therein. The inhalation filter has a joining pipe that is securely inserted into the engaging slot of the associated seat. The inhalation valve is disposed at inside of the mask housing or inside of the inhalation filter, which is provided to prevent the air in the mask housing from expelling to outside of the mask housing. Preferably, the mask of the present invention further comprises a conducting passage disposed inside of the inhalation filter and having two opposite ends. The conducting passage narrows gradually with a curve from one end being far away from the mask housing toward the other end being close to the mask housing, which is applied to enables the air being efficiently guided into the inside of the mask housing so as to significantly reduce a burden while inhaling. More preferably, the mask of the present invention further comprises the aforementioned elements like the ring-shaped bladder and the engaging ring, which features a replaceable ring-shape bladder.

Compared with prior art, the present invention provides for a simple assembly of the mask that can be easily assembled, which accordingly solve the problems existing in the conventional mask, that is the whole mask has to be discarded once the airbag is damaged. Furthermore, the present invention is provided with a mask which efficiently increase a burden while inhaling due to the design of the aforementioned conducting passage. In addition, the mask of the present invention can well decrease a burden while exhaling and keep the air in the mask fresh by usage of the aforementioned exhaust module as well.

Other features, objects, aspects and advantages will be identified and described in detail below.

### BRIEF DESCRIPTION OF DRAWINGS

FIG. 1 is a stereo front perspective view of a mask in accordance with a first embodiment of the present invention.

FIG. 2 is a stereo back perspective view of the mask in accordance with the first embodiment of the present invention.

FIG. 3 is an exploded back view of the mask in FIG. 2.

FIG. 4 is another stereo perspective view of the mask in accordance with a first embodiment of the present invention.

FIG. 5 is an exploded back view of the mask in FIG. 4.

FIG. 6 is a cross-sectional view of the mask taken on line VI-VI of FIG. 4.

FIG. 7 is a cross-sectional view of the mask taken on line VII-VII of FIG. 4.

FIG. 8 is a stereo front perspective view of a mask in accordance with a second embodiment of the present invention.

FIG. 9 is a stereo back perspective view of the mask in accordance with the second embodiment of the present invention.

FIG. 10 is an exploded back view of the mask in FIG. 9.

FIG. 11 is a cross-sectional view of the mask taken on line XI-XI of FIG. 8.

FIG. 12 is a stereo perspective view of a mask in accordance with a third embodiment of the present invention.

FIG. 13 is an exploded back view of the mask in FIG. 12.

FIG. 14 is a cross-sectional view of the mask taken on line XIV-XIV of FIG. 12.

FIG. 15 is a perspective view of a traditional mask.

### DETAILED DESCRIPTION OF EMBODIMENTS

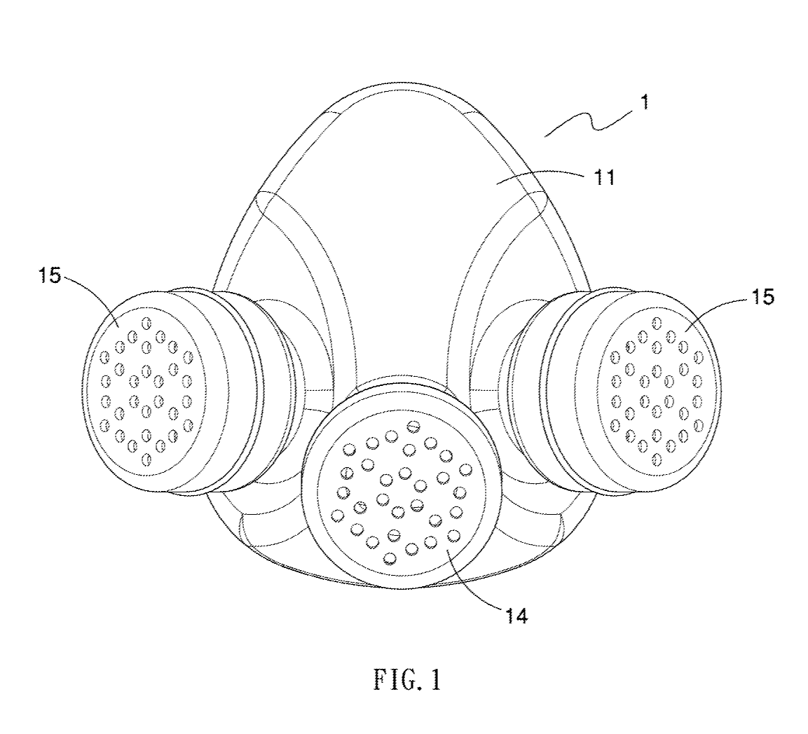

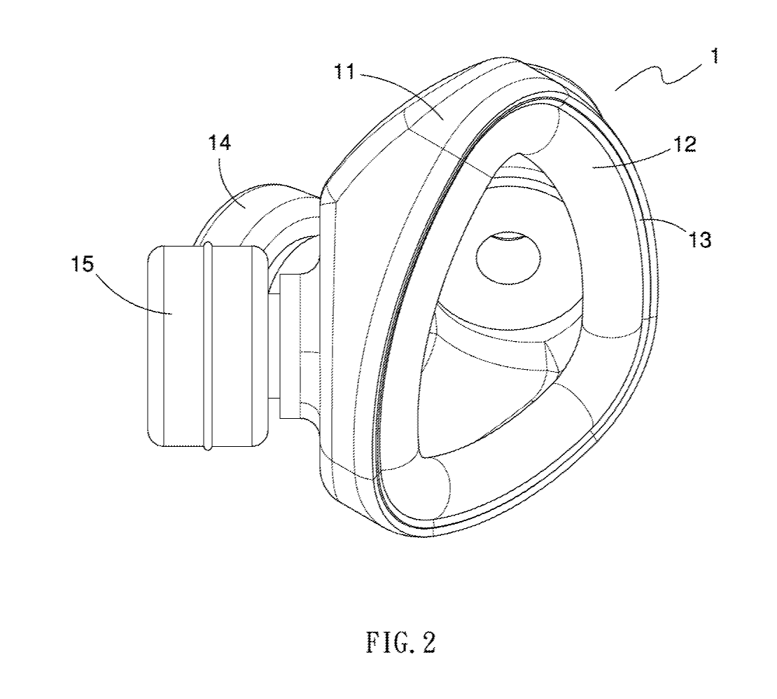

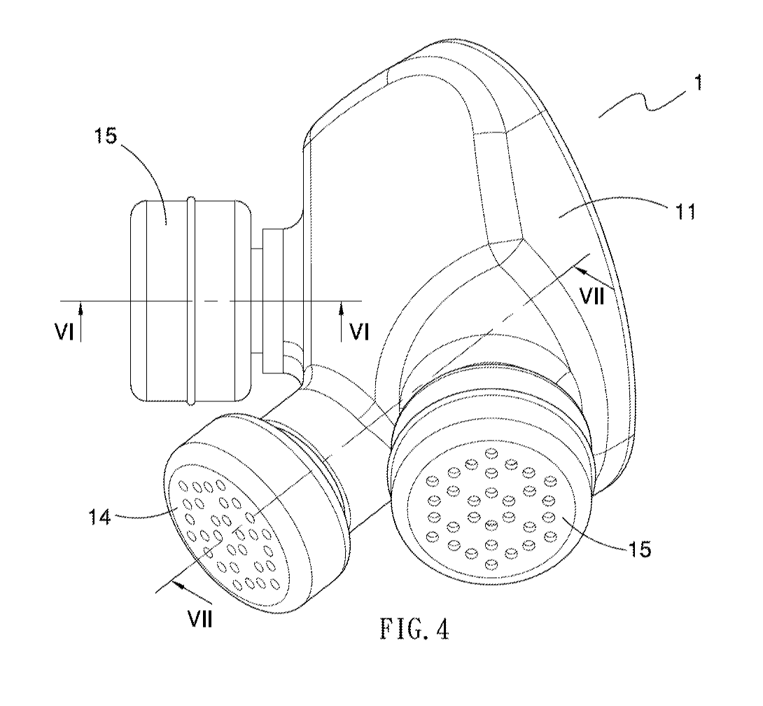

FIG. 1 to FIG. 7 are perspective drawings showing a mask 1 in accordance with a first embodiment of the present invention. In this embodiment, the mask 1 is a filter mask or a gas mask that can be applied to filter harmful substances or airborne pollutants. FIG. 1, FIG. 2 and FIG. 4 are stereo perspective views of the mask 1 from different view angles in accordance with the first embodiment of the present invention. The mask 1 comprises a mask housing 11, a ring-shaped bladder 12, an engaging ring 13, an exhaust assembly 14 disposed at a center of exterior front side of the mask housing 11, and two inhalation filters 15 respectively disposed at two sides of the exhaust assembly 14.

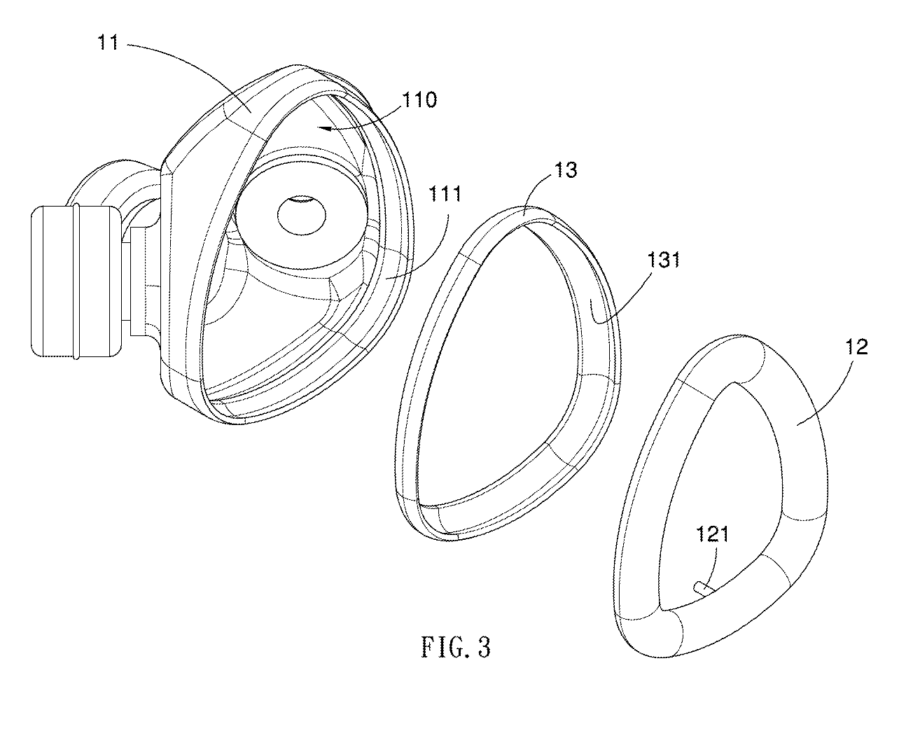

With reference to FIG. 3, the mask housing 11 is made of a first material that is rigid and impermeable. The first material is preferably selected from rigid non-foam plastic materials. In this embodiment, the first material is preferably polycarbonate or fiberglass, but not limited thereto. The ring-shaped bladder 12 is made of a second material that is soft and airtight. The second material is preferably selected from soft non-foam plastic materials, such as polyvinyl chloride, ethylene vinyl acetate or silica gel. In this embodiment, the second material is preferably silica gel, but not limited thereto. Moreover, in this embodiment, the ring-shaped bladder 12 includes an inflating valve 121 disposed at exterior surface of the ring-shaped bladder 12 to supply air, but not limited thereto. Alternatively, the ring-shaped bladder 12 can be designed as a thorough sealed bladder that does not have an inflating valve 121 attached thereon. The engaging ring 13 is made of a third material, and hardness of the third material is between that of the first material and the second material. The third material is a flexible non-foam plastic material. In this embodiment, the third material is preferably thermo plastic rubber, but not limited thereto.

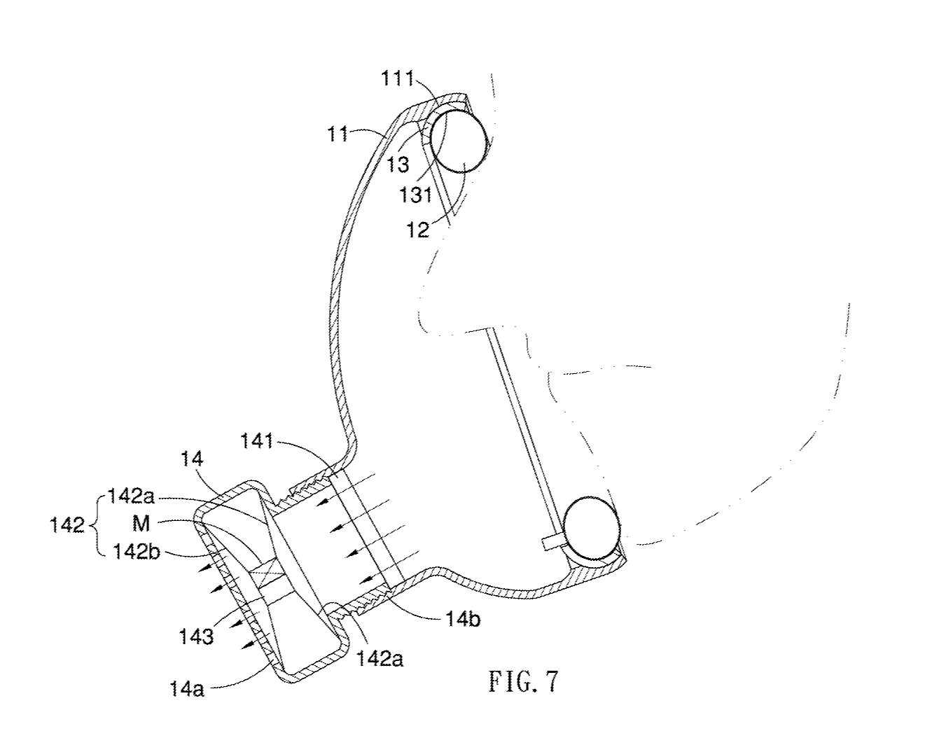

With reference to FIG. 3 and FIG. 7, the mask housing 11 has an opening 110 defined in a rear side thereof. The engaging ring 13 is detachably clasped onto the rear side of the mask housing 11 so as to secure the ring-shaped bladder 12 in the opening 110 of the mask housing 11. More specifically, in this embodiment, the mask housing 11 includes an annular groove 111 defined in the inner walls of the opening 110. The outer edge of the engaging ring 13 is securely fitted into the annular groove 111. The engaging ring 13 further has a ring-shaped engaging trench 131 defined in the inner circular surface thereof. The ring-shaped bladder 12 is firmly engaged within the ring-shaped engaging trench 131. As shown in FIG. 7, the engaging trench 131 is an arc trench corresponding to the ring-shaped bladder 12 so as to enable the ring-shaped bladder 12 to be fitted into the engaging trench 131 to insure a proper seal.

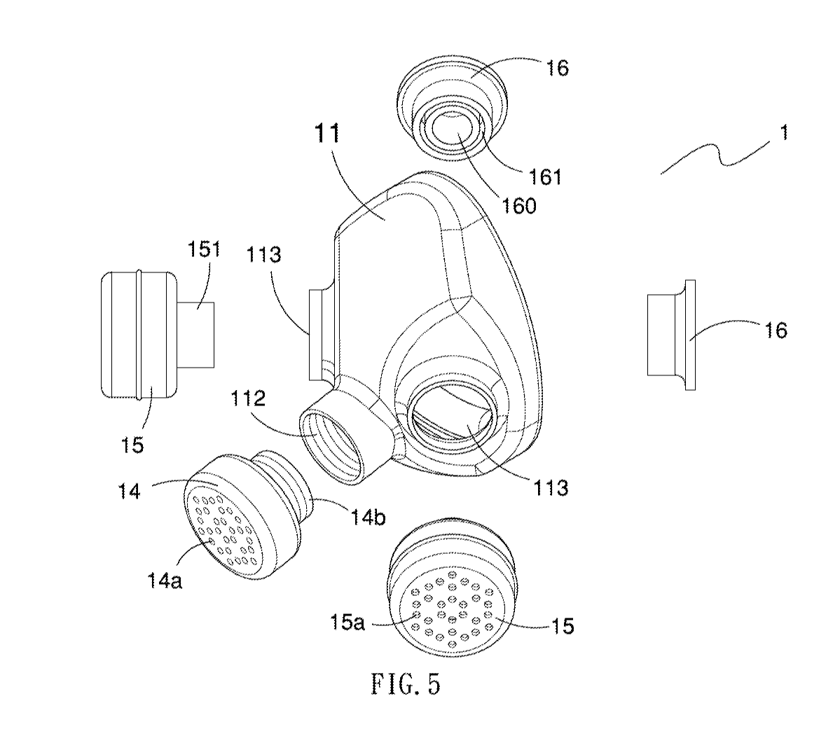

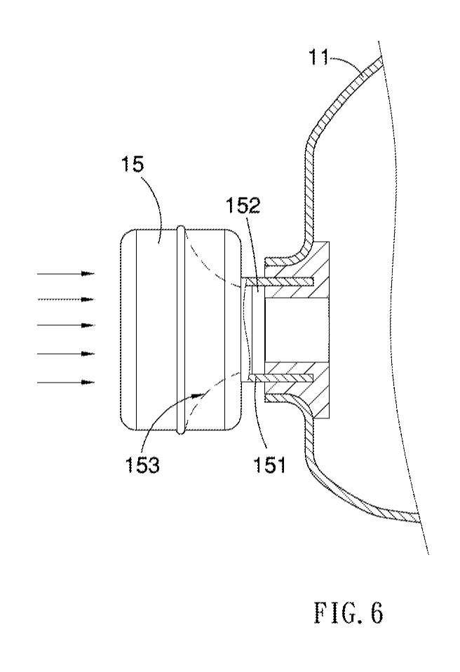

With reference to FIG. 5 and FIG. 7, the mask housing 11 has a hole 112 defined at the front side thereof and two air inlet holes 113 defined at front side thereof and located at two sides of the hole 112 respectively. The exhaust assembly 14 is connected to the hole 112 of the mask housing 11, and the two inhalation filters 15 are respectively connected into the air inlet holes 113 by thread connections, fastening connections or any other connections. For instance, the mask 1 further comprises two associated seats 16 each respectively fitted into the two air inlet holes 113 of the mask housing 11. The two inhalation filters 15 are respectively connected into the air inlet holes 113 by the associated seats 16. More specifically, each of the two associated seats 16 has a hollow 160 defined therethrough and an engaging slot 161 surrounding the hollow 160. The associated seats 16 are made of a resilient non-foam plastic material, preferably thermo plastic rubber, but not limited thereto. Preferably, the air inlet holes 113 are slightly smaller than the associated seats 16 in size so as to enable the resilient associated seats 16 firmly snap fit in the air inlet holes 113 to insure a proper seal, as shown in FIG. 6. The two inhalation filters 15 respectively include a joining pipe 151 outwardly protruded therefrom. The joining pipe 151 is completely inserted into the engaging slot 161 of the associated seat 15. Preferably, the engaging slot 161 has a slot width smaller than a wall thickness of the joining pipe 151 in order to form a tight seal of the joining pipe 151 and the engaging slot 161 by virtue of the resilience of the associated seats 16, as shown in FIG. 6. Therefore, it is understood that the two associated seats 16 are directly fitted into the air inlet holes 113, respectively, and the two inhalation filters 15 are directly seated into the two associated seats 16, respectively. This provides for the inhalation filters to be easily assembled onto the associated seats 16 so as to form a proper airtight seal of the two inhalation filters 15 and the two associated seats 16, preventing unfiltered exterior air from entering the interior of the mask housing 11 through the inhalation filters 15.

With reference to FIG. 5 and FIG. 7, the exhaust assembly 14 includes a connecting tube 14b and a plurality of apertures 14a. In one embodiment, the exhaust assembly 14 may include a filter (not shown in the drawings) placed therein as needed. Preferably, the connecting tube 14b is screwed to the mask housing 11, but not limited thereto. For example, the connections of the connecting tube 14b and the mask housing 11 can be selected by a similar connection way like the previous mentioned connections of the joining pipe 15 and the associated seat 16. It thus appears that the air in the mask 11 can be expelled to outside of the mask housing through the connecting tube 14b, filter and apertures 14a. With reference to FIG. 5 and FIG. 6 again, the two inhalation filters 15 further includes a plurality of perforations 15a defined therein and a filter material and/or an absorbing material placed therein (not shown in the drawings). The absorbing material can be chosen from materials of activated carbon and other absorbing materials that can absorbs pollutants, toxic substances or hazardous substances. It is to be appreciated that the exterior air is drawn into the mask housing 11 through the filter material and/or the absorbing material of the inhalation filters 15, joining pipe 151, and the associated seats 16 in sequence.

With reference to FIG. 6, the mask 1 further comprises an inhalation valve 152 and a conducting passage 153. The inhalation valve 152 indicated briefly in the drawing can be selected by a one-way diaphragm valve, which only allows exterior air into the mask housing 11 without allowing air to be expelled from the mask housing 11. The inhalation valve 152 can be attached inside of the mask housing 11; alternatively, that can be attached to a position where is inside of the inhalation filter 15 and is adjacent to the mask housing 11, according to the demands. In one embodiment, the inhalation valve 152 can be disposed in the inside of the joining pipe 151. Thus, the air that is sucked by the inhalation filter 15 subsequently passes through the filter material and/or the absorbing material and the inhalation valve 152 that permits one-way air flow movement, which accordingly the air in the mask housing 11 is well purified for the user to breathe. Moreover, the conducting passage 152 indicated briefly in the drawing is disposed inside of the inhalation filter 15 and has two opposite ends. The interior surface of the conducting passage 152 narrows gradually with a curve from one end being far away from the mask housing 11 toward the other end being close to the mask housing 11, such as in a funnel-like shape or a trumpet-like shape. Accordingly, noted that the air would be efficiently guided into the inside of the mask housing 11 by the conducting passage 152 that would decrease resistance to airflow through the inhalation filters 15 after the exterior air firstly passes through the filter material and/or the absorbing material of the two inhalation filters 15, thereby significantly improving the inhalation performance.

With reference to FIG. 7, the mask 1 further comprises an exhalation valve 141. The exhaust assembly 14 further includes an exhaust module 142 disposed therein. Preferably, the exhaust assembly 14 further includes a bypass channel 143. The exhalation valve 141 as briefly shown in the drawing can be a one-way diaphragm valve that allows the air in the mask housing 11 to be discharged and prevents exterior air from going into the inside of the mask housing 11. The exhalation valve 141 can be attached inside of the mask housing 11 according to the demands as shown in the drawing; alternatively, the exhalation valve 141 can be attached to a position where is inside of the exhaust assembly 14 and is close to the mask housing 11 as well. The exhaust module 142 as briefly illustrated in the drawing includes an entrance 142a, an exit 142b and a micropump M connected to both of the entrance 142a and the exit 142b. The entrance 142a and the exit 142b are in a form of a funnel-like shape or a trumpet-like shape as shown in the drawing, but not limited thereto. It is essential that one end of the entrance 142a is connected to a suction port of the micropump M (not shown in the drawing) and communicates with the connecting tube 14b, and one end of the exit 142b is connected to a discharge port of the micropump M not shown in the drawing) and communicates with the apertures 14a. The exhaled air from the user can be sucked from the inside of the mask housing 11 to the outside by the micropump M through the exhalation valve 141, entrance 142a, exit 142b and apertures 14a. Therefore, this evidences that the exhaled air in the mask housing 11 can be automatically expelled from the mask housing 11 because of the design of the exhaust module 142, which keeps the air in the mask housing 11 fresh and reduces a burden while exhaling. Based upon this concept, an additional inhalation module (not shown in the drawing) may be also provided with the aforementioned inhalation filters 15 according to the demand, which has the same or similar functions to the exhaust module 142 so as to assist the user to inhale efficiently and reduce a burden while inhaling.

The bypass channel 143 communicates the entrance 142a and the exit 142b, which is served as an exhaust path detouring around the micropump M. The bypass channel 143 has a gate (not shown in the drawing) disposed therein, and the exhaust assembly 14 further includes a control piece (not shown in the drawing), like an on-off control or a switch, to control the gate. When the micropump is switched on and the gate is switched off, the bypass channel 143 cannot communicate the entrance 142 and the exit 142b. At this situation, the exhaled air in the mask housing 11 can be expelled forcibly from the mask housing 11 by the micropump M, ensuring the air in the mask housing 11 fresh. If the user considers that there is no need to turn on the micropump M, only the gate is switched on that enables the bypass channel 143 to communicate the entrance 142a and the exit 142b. At this moment, the exhaled air in the mask housing 11 can be expelled from the mask housing 11 through the path of the bypass channel 143, the entrance 142a, the exit 142b and the apertures 14a. In this embodiment, the user can select either the micropump M or the bypass channel 143 to expel according to the demands.

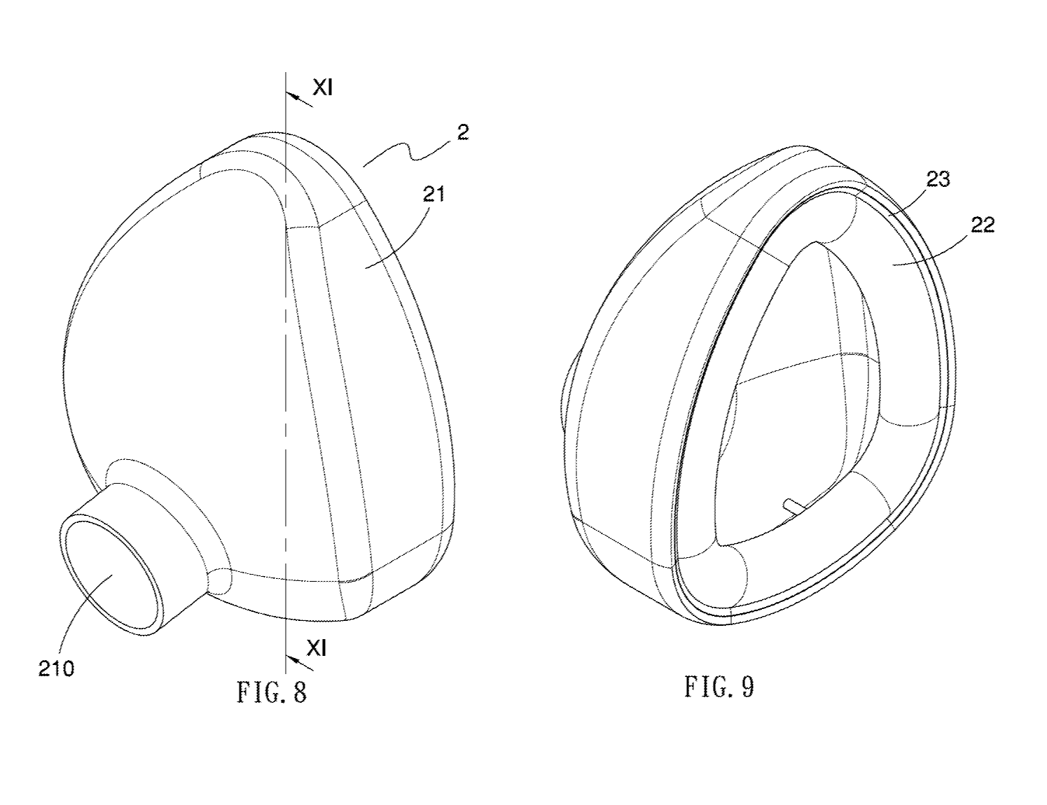

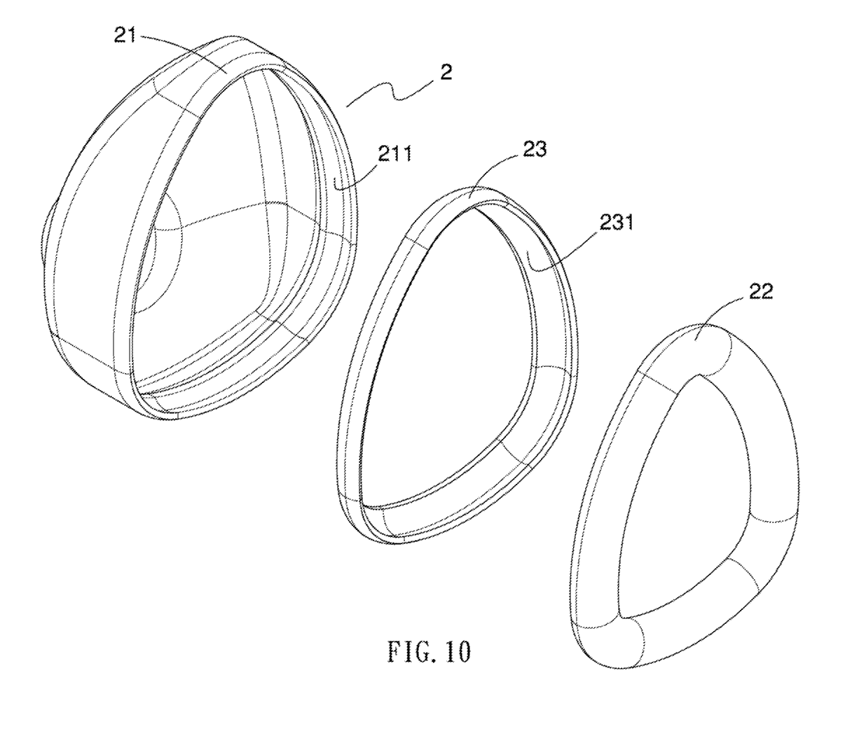

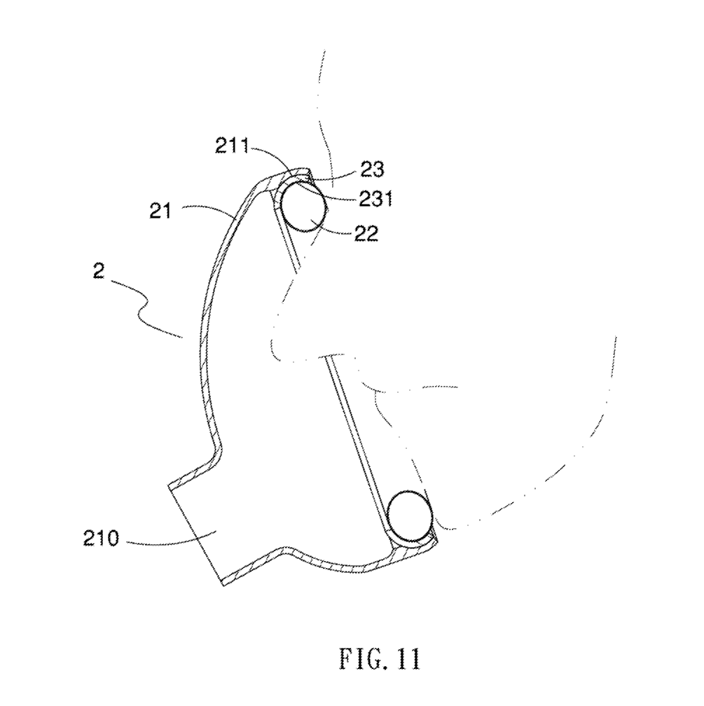

FIG. 8 to FIG. 11 are perspective drawings showing a mask 2 in accordance with a second embodiment of the present invention. In this embodiment, the mask 2 is a medical oxygen mask, which shows that there is needless to assemble the aforementioned components like the exhaust assembly 14 and the inhalation filters 15 as illustrated in the previous embodiment. FIG. 8 and FIG. 9 are stereo perspective views of the mask 2 in accordance with a second embodiment of the present invention. The mask 2 comprises a mask housing 21, a ring-shaped bladder 22, an engaging ring 23 and an air inlet hole 210 connected to an oxygen tube (not shown in the drawing). Configurations and materials of the mask housing 21, the ring-shaped bladder 22 and the engaging ring 23 in the second embodiment are substantially identical to those mentioned in the first embodiment. It is appreciated that the mask 2 in the second embodiment is an oxygen mask, which differs from the configuration of the mask 1 in the first embodiment. With reference to FIG. 10 and FIG. 11, the mask housing 21 includes an annular groove 211 defined in the inner walls of the opening 310 (should be amended as 212). The outer edge of the engaging ring 23 is fitted into the annular groove 211. The engaging ring 23 further has a ring-shaped engaging trench 231 defined in the inner circular surface thereof. The ring-shaped bladder 22 is engaged within the ring-shaped engaging trench 231.

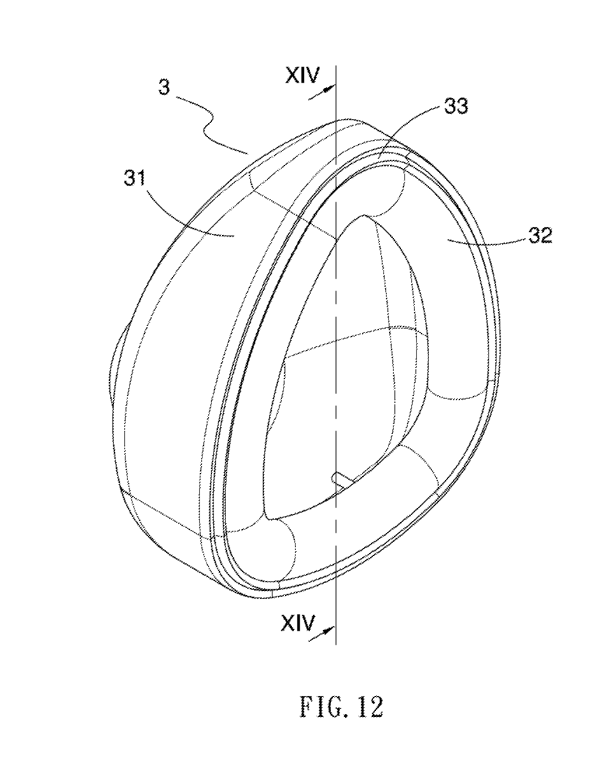

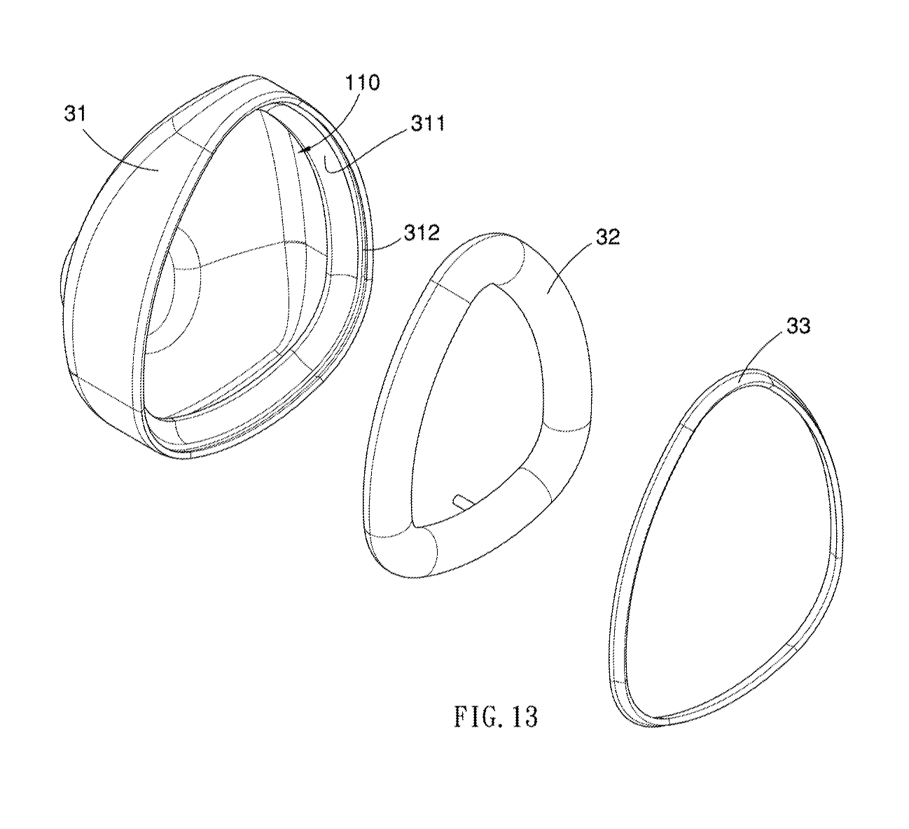

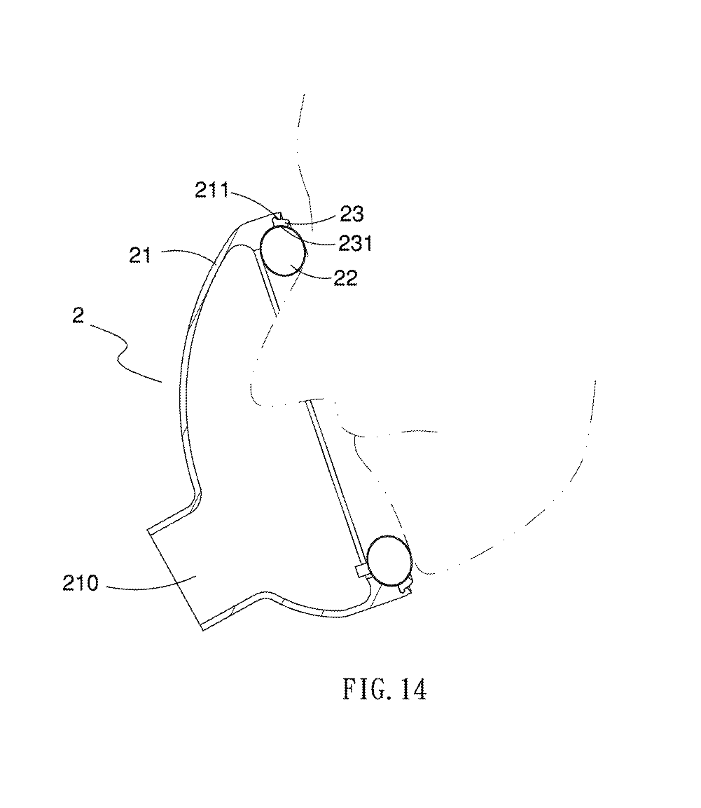

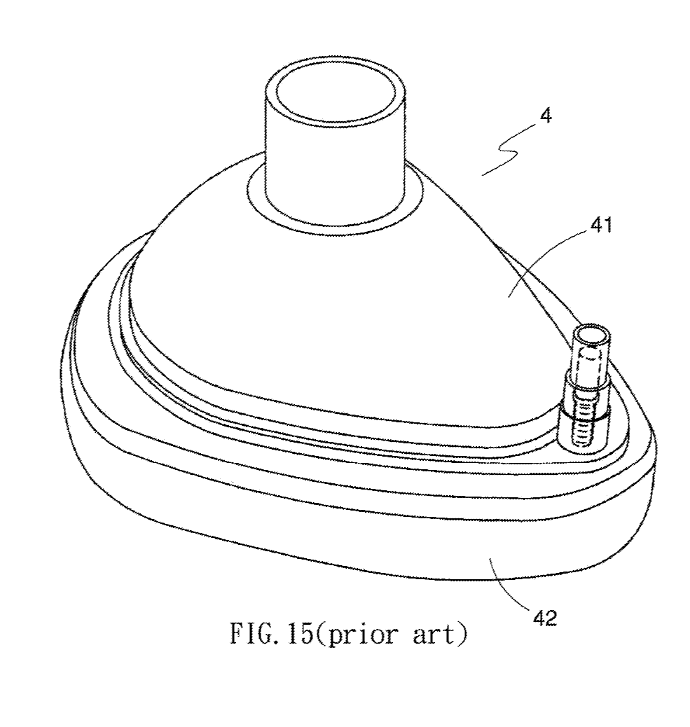

FIG. 12 to FIG. 14 are perspective drawings showing a mask 3 in accordance with a third embodiment of the present invention. In this embodiment, the mask 3 is a medical oxygen mask. Components, materials and features of the mask 3 in the third embodiment are substantially identical to those of the mask 2 in the second embodiment. The only difference between the mask 2 and the mask 3 is that the mask housing 31 includes an internal annular groove 311 and an external annular groove 321 respectively defined in the inner wall of the opening 310. The internal annular groove 311 is adjacent to the external annular groove 321. The engaging ring 33 is a flat and thin ring piece. First, the ring-shaped bladder 32 is firmly engaged within the internal annular groove 311, and the engaging ring 33 is then firmly fitted into the external annular groove 312 and stop against the edge of the ring-shaped bladder 32. This prevents the ring-shaped bladder 32 from falling off from the opening 310 of the mask housing 31.

It can be seen, therefore, the present invention is provided for a simple assembly of the mask that can be easily assembled due to the design of the components like the engaging ring, which accordingly allows the user to replace a new ring-shaped bladder according to the demands. This arrangement uniquely solves the discard problems. Moreover, the present invention is provided with a mask which allows the air fluently to be directed into the inside of the mask by the aforementioned conducting passage of the inhalation filter, with reduced burden while inhaling. In addition, the mask of the present invention can well decrease a burden while exhaling and keep the air in the mask fresh by usage of the aforementioned exhaust assembly as well.

It will be appreciated that although a particular embodiment of the invention has been shown and described, modifications may be made. It is intended in the claims to cover such modifications which come within the spirit and scope of the invention.

The invention claimed is:

1. A mask comprising:
a mask housing including an hole defined at a front side thereof and an opening defined in a rear side thereof;
an engaging ring being flexible and detachably clasped onto the opening of the mask housing; and
a ring-shaped bladder engaged within the engaging ring.

2. The mask of claim 1, wherein the mask housing includes an annular groove defined in an inner wall of the opening, and outer edge of the engaging ring is fastened in the annular groove; wherein the engaging ring has a ring-shaped engaging trench defined in inner circular surface thereof, and the ring-shaped bladder is fastened in the ring-shaped engaging trench.

3. The mask of claim 1, wherein the mask housing includes an internal annular groove and an external annular groove each defined in an inner wall of the opening, and the internal annular groove is adjacent to the external annular groove; wherein the ring-shaped bladder is fastened in the internal annular groove, and the engaging ring is fastened in the external annular groove and stop against an edge of the ring-shaped bladder to prevent the ring-shaped bladder from falling off.

4. The mask of claim 1, further comprising an exhaust assembly connected to the hole of the mask housing and an exhaust module disposed in the exhaust assembly; wherein the exhaust module includes an entrance, an exit and a micropump connected to both of the entrance and the exit; and wherein the micropump is provided to suck the air from the mask housing through the entrance and to discharge to the outside of the mask housing through the exit.

5. The mask of claim 4, further comprising a bypass channel communicating the entrance and the exit; wherein the bypass channel is configured to be switched on and off selectively.

6. The mask of claim 1, further comprises an associated seat and an inhalation filter, wherein the associated seat is resilient and fitted into an air inlet hole of the mask housing, and the associated seat has an engaging slot defined therein that allows the inhalation filter to be fastened in the engaging slot of the associated seat.

7. The mask of claim 2, further comprises an associated seat and an inhalation filter, wherein the associated seat is resilient and fitted into an air inlet hole of the mask housing, and the associated seat has an engaging slot defined therein that allows the inhalation filter to be fastened in the engaging slot of the associated seat.

8. The mask of claim 3, further comprises an associated seat and an inhalation filter, wherein the associated seat is resilient and fitted into an air inlet hole of the mask housing, and the associated seat has an engaging slot defined therein that allows the inhalation filter to be fastened in the engaging slot of the associated seat.

9. The mask of claim 4, further comprises an associated seat and an inhalation filter, wherein the associated seat is resilient and fitted into an air inlet hole of the mask housing, and the associated seat has an engaging slot defined therein that allows the inhalation filter to be fastened in the engaging slot of the associated seat.

10. The mask of claim 5, further comprises an associated seat and an inhalation filter, wherein the associated seat is resilient and fitted into an air inlet hole of the mask housing, and the associated seat has an engaging slot defined therein that allows the inhalation filter to be fastened in the engaging slot of the associated seat.

11. The waterproof bag of claim 6, further includes a conducting passage disposed inside of the inhalation filter and having two opposite ends, wherein an interior surface of the conducting passage narrows gradually with a curve from one end being far away from the mask housing toward the other end being close to the mask housing.

12. The waterproof bag of claim 7, further includes a conducting passage disposed inside of the inhalation filter and having two opposite ends, wherein an interior surface of the conducting passage narrows gradually from one end being far away from the mask housing toward the other end being close to the mask housing with a curve.

13. The waterproof bag of claim 8, further includes a conducting passage disposed inside of the inhalation filter and having two opposite ends, wherein an interior surface of the conducting passage narrows gradually from one end being far away from the mask housing toward the other end being close to the mask housing with a curve.

14. The waterproof bag of claim 9, further includes a conducting passage disposed inside of the inhalation filter and having two opposite ends, wherein an interior surface of the conducting passage narrows gradually from one end being far away from the mask housing toward the other end being close to the mask housing with a curve.

15. The waterproof bag of claim 10, further includes a conducting passage disposed inside of the inhalation filter and having two opposite ends, wherein an interior surface of the conducting passage narrows gradually from one end being far away from the mask housing toward the other end being close to the mask housing with a curve.

16. A mask comprising:
a mask housing;
an exhaust assembly, connected to the mask housing; and
an exhaust module, disposed in the exhaust assembly, the exhaust module including an entrance, an exit and a micropump connected to both of the entrance and the exit, wherein the micropump is provided to suck the air from the mask housing through the entrance and to discharge to the outside of the mask housing through the exit.

17. The mask of claim 16, further comprising a bypass channel communicating the entrance and the exit; wherein the bypass channel is configured to be switched on and off selectively.

18. A mask comprising:
a mask housing;
an associated seat, fitted into an air inlet hole of the mask housing, being resilient, and having an engaging slot defined therein; and
an inhalation filter, fastened in the engaging slot of the associated seat.

19. The mask of claim 18, further comprising a conducting passage disposed inside of the inhalation filter and having two opposite ends, wherein an interior surface of the conducting passage narrows gradually with a curve from one end being far away from the mask housing toward the other end being close to the mask housing.
